(19) United States
(12) Patent Application Publication
(10) Pub. No.: US 2024/0265315 A1
(43) Pub. Date: Aug. 8, 2024

(54) SYSTEM AND METHOD FOR PREDICTING LEVEL OF CONGESTION AT CHARGING STATIONS

(71) Applicant: HL Mando Corporation, Pyeongtaek-si (KR)

(72) Inventor: Yeon Joon HAN, Pyeongtaek-si (KR)

(21) Appl. No.: 18/434,999

(22) Filed: Feb. 7, 2024

(30) Foreign Application Priority Data
Feb. 7, 2023 (KR) 10-2023-0016266

(51) Int. Cl. G08G 1/01; G06Q 10/04

(52) U.S. Cl. CPC G06Q 10/04; G08G 1/0133

(57) ABSTRACT

The present disclosure relates to a system and a method for predicting the level of congestion at a charging station. The system for predicting the level of congestion at the charging station may include the following units: a prediction model unit, a change calculation unit, and a predicted value correction unit.

### CROSS-REFERENCE TO RELATED APPLICATIONS

The present application claims the benefit of priority to Korean Patent Application No. 10-2023-0016266 filed on Feb. 7, 2023 in the Korean Intellectual Property Office. The aforementioned applications are hereby incorporated by reference in their entireties.

### TECHNICAL FIELD

The present disclosure relates to a system and a method for predicting the level of congestion at a charging station, where the congestion level at charging stations is predicted based on an artificial intelligence model, and a predicted value is corrected by applying a weight based on the variance in the number of waiting vehicles, so that the reliability of the predicted value is improved.

### BACKGROUND

Users of eco-friendly vehicles such as electric or hydrogen cars use charging stations to charge their eco-friendly vehicles. When there is a need to wait to charge an eco-friendly car, a driver checks the number of vehicles waiting at the charging station, takes the waiting time into account, and either waits at the charging station to charge or moves to another charging station.

According to the present disclosure, the number of vehicles waiting at a charging station at a future point in time is predicted based on an artificial intelligence model, and a fuzzy-based model for predicting the congestion level is proposed by applying the above-described behavior patterns of users. The fuzzy theory is used to express uncertain states, and has been widely used for controlling vehicles, home appliances, etc. The present disclosure relates to reliably predicting the number of vehicles waiting at a charging station by reflecting the above-mentioned behavior patterns of users of charging stations.

### SUMMARY

The present disclosure has been made in an effort to resolve the above-mentioned problems, and is aimed at providing a system and a method for predicting the level of congestion at a charging station, where the congestion level at charging stations is predicted based on an artificial intelligence model, and a predicted value is corrected by applying a weight based on the variance in the number of waiting vehicles, so that the reliability of the predicted value is improved.

A system for predicting the level of congestion at a charging station according to an aspect of the present disclosure may include a prediction model unit that collects information on the number of vehicles waiting at a charging station for charging during a predetermined period of time and calculates a predicted value for the number of vehicles waiting at a predetermined future time point based on the number of waiting vehicles and the factors affecting the number of waiting vehicles; a change calculation unit that calculates the variance in the number of vehicles waiting at a prediction time based on the number of vehicles waiting at the prediction time at which the predicted value is calculated and that at a predetermined past time; and a predicted value correction unit that corrects the predicted value by giving a weight to each of the predicted value and the actual number of vehicles waiting at the prediction time based on the variance in the number of waiting vehicles calculated by the change calculation unit.

In order to calculate the variance in the number of waiting vehicles using the change calculation unit, the average numbers of vehicles waiting at each time point may be calculated, the variance in the numbers of waiting vehicles at each time point may be calculated based on the average numbers of waiting vehicles, and the ratio of the variance at the prediction time to the difference between the maximum and minimum values of the variances at each time point before the prediction time may be calculated.

A preset weight may be given to each of the predicted value and the actual number of waiting vehicles based on the level of congestion classified according to the variance in the numbers of waiting vehicles.

The level of congestion may be classified into at least three levels.

The ratio may be converted into a percentage and expressed as the variance in the number of waiting vehicles, the level of congestion may be classified as follows: 1) If the variance in the number of waiting vehicles≥+50%, crowded; 2) If −50%<the variance in the number of waiting vehicles<+50%, normal; and 3) If the variance in the number of waiting vehicles≤−50%, not crowded, and different weights may be given depending on the level of congestion.

When the weight given to the predicted value and the weight given to the actual number of waiting vehicles are M and m, respectively, and M+m=1, the M value in the crowded state may be less than the M value in the non-crowded state, and the m value in the crowded state may be greater than the m value in the non-crowded state.

When the weight given to the predicted value and the weight given to the actual number of waiting vehicles are M and m, respectively, and M+m=1, in the crowded state, weights of M=0.55 to 0.65 and m=0.35 to 0.45 may be given; in the normal state, weights of M=0.5 and m=0.5 may be given; and, in the non-crowded state, weights of M=0.75 to 0.85 and m=0.15 to 0.25 may be given.

The predicted value and the variance in the number of waiting vehicles may be calculated at 1-hour intervals.

The prediction model unit may calculate a measured value for the number of vehicles waiting at a predetermined future time point based on any one of machine learning algorithms such as XGBoost, LightGBM, KNeighbors, and RandomForest Regression.

The prediction model unit may calculate a measured value for the number of vehicles waiting at a predetermined future time point based on either LSTM or GRU of the recurrent neural network (RNN) series.

Meanwhile, a method of predicting the level of congestion at a charging station according to another aspect of the present disclosure may involve calculating a predicted value, where information on the number of vehicles waiting at a charging station for charging during a predetermined period of time is collected and a predicted value for the number of vehicles waiting at a predetermined future time point is calculated based on the number of waiting vehicles and the factors affecting the number of waiting vehicles; calculating variance, where the variance in the number of vehicles waiting at a prediction time is calculated based on the number of vehicles waiting at the prediction time at which the predicted value is calculated and that at a predetermined past time; and correcting a predicted value, where the predicted value is corrected by giving a weight to each of the predicted value and the actual number of vehicles waiting at the prediction time based on the variance in the number of waiting vehicles calculated in the calculating of variance.

In order to calculate the variance in the number of waiting vehicles in the calculating of variance, the average numbers of vehicles waiting at each time point may be calculated, the variance in the numbers of waiting vehicles at each time point may be calculated based on the average numbers of waiting vehicles, and the ratio of the variance at the prediction time to the difference between the maximum and minimum values of the variances at each time point before the prediction time may be calculated.

A preset weight may be given to each of the predicted value and the actual number of waiting vehicles based on the level of congestion classified according to the variance in the number of waiting vehicles.

The level of congestion may be classified into at least three levels.

The ratio may be converted into a percentage and expressed as the variance in the number of waiting vehicles, the level of congestion may be classified as follows: 1) If the variance in the number of waiting vehicles≥+50%, crowded; 2) If −50%<the variance in the number of waiting vehicles<+50%, normal; and 3) If the variance in the number of waiting vehicles≤−50%, not crowded, and different weights may be given depending on the level of congestion.

When the weight given to the predicted value and the weight given to the actual number of waiting vehicles are M and m, respectively, and M+m=1, the M value in the crowded state may be less than the M value in the non-crowded state, and the m value in the crowded state may be greater than the m value in the non-crowded state.

When the weight given to the predicted value and the weight given to the actual number of waiting vehicles are M and m, respectively, and M+m=1, in the crowded state, weights of M=0.55 to 0.65 and m=0.35 to 0.45 may be given; in the normal state, weights of M=0.5 and m=0.5 may be given; and, in the non-crowded state, weights of M=0.75 to 0.85 and m=0.15 to 0.25 may be given.

The predicted value and the variance in the number of waiting vehicles may be calculated at 1-hour intervals.

In the calculating of a predicted value, a predicted value for the number of vehicles waiting at a predetermined future time point may be calculated based on any one of machine learning algorithms such as XGBoost, LightGBM, KNeighbors, and RandomForest Regression.

In the calculating of a predicted value, a predicted value for the number of vehicles waiting at a predetermined future time point may be calculated based on either LSTM or GRU of the recurrent neural network (RNN) series.

According to an embodiment of the present disclosure, there may be provided a system and a method for predicting the level of congestion at a charging station, where the congestion level at charging stations is predicted based on an artificial intelligence model, and a predicted value is corrected by applying a weight based on the variance in the number of waiting vehicles, so that the reliability of the predicted value is improved.

That is, the number of waiting vehicles may be predicted for the first time using an artificial intelligence model, and the value that has been predicted as mentioned above may be corrected by reflecting the behavior patterns of users to decide whether to use a charging station based on the level of congestion, so that it may be possible to improve accuracy by reflecting the ever-changing conditions in the environment in the predicting system.

In the case of the system and the method for predicting the level of congestion at a charging station according to an embodiment of the present disclosure, it may be possible to follow the trend of changes in the actual number of waiting vehicles very accurately by giving different weights depending on the level of congestion. Accordingly, users can decide whether to use a charging station based on more accurate results, so that convenience may be improved, the density of charging stations may be distributed, and the prediction results may be used to predict demand for charging accurately.

### BRIEF DESCRIPTION OF THE DRAWINGS

FIG. 1 is a block diagram of a system for predicting the level of congestion at a charging station according to an embodiment of the present disclosure.

FIG. 2 is a flowchart of the process of correcting a predicted value.

FIG. 3 is a view conceptually showing the variances in the number of waiting vehicles at each time point,

FIG. 4 is a view showing the level of congestion classified according to the variance in the number of waiting vehicles.

FIG. 5 is a view showing a comparison between predicted values calculated by a prediction model unit and the predicted values corrected by a predicted value correction unit over a certain period of time.

FIG. 6 is a flowchart of a method of predicting the level of congestion at a charging station according to an embodiment of the present disclosure.

### DETAILED DESCRIPTION

Hereinafter, the various embodiments of the present disclosure will be described with reference to the accompanying drawings. A range of changes can be made to the embodiments of the present disclosure, and various embodiments can be made. Therefore, specific embodiments have been illustrated in the drawings, and the detailed descriptions related thereto have been described. However, this is not intended to limit the various embodiments of the present disclosure to specific embodiments, and the various embodiments of the present disclosure should be understood to include all changes and/or equivalents or substitutes within the technology and the scope thereof. In terms of the description of the drawings, similar reference numbers have been used for similar components.

The terms used in the present disclosure are merely used to describe specific embodiments and may not be used with the intention of limiting the scope of other embodiments. Expressions in the singular form may include the meaning of the plural form unless they clearly mean otherwise in the context. The terms used herein, including technical or scientific terms, may have meanings commonly understood by a person having ordinary skill in the technical field to which the present disclosure pertains. Among the terms used in the present disclosure, those defined in general dictionaries may be interpreted to have the same or similar meaning as the meaning they have in the context of related technology, and should not be interpreted in an ideal or excessively formal sense unless clearly defined in the present disclosure. In some cases, even the terms defined in the present disclosure cannot be interpreted to exclude embodiments of the present disclosure.

For the various embodiments of the present disclosure described below, a hardware-based method is described as an example. However, because various embodiments of the present disclosure include technology using both hardware and software, software-based methods are not excluded from the various embodiments of the present disclosure.

Hereinafter, the various embodiments will be described in detail with reference to the attached drawings so that a person having ordinary skill in the art can easily perform them. However, because the technology of the present disclosure can be modified and carried out in various forms, it is not limited to the embodiments described in the present disclosure. In connection with describing the embodiments disclosed in the present disclosure, when it is determined that detailed description of related known technologies may obscure the gist of the technology of the present disclosure, the detailed descriptions of the known technologies will not be provided. The same or similar components are given the same reference number, and descriptions thereof are not repeatedly provided.

When a component is described as being “connected” to another component in the present disclosure, the component is either “directly connected” to the other component or “indirectly connected” thereto with another component in between. When a component is described as “including” another component, it does not mean that the component excludes components other than the other component, but that it may further include the components unless specifically stated to the contrary.

Some embodiments may be described in terms of functional block features and various processing steps. Some or all of those functional blocks may be in the form of any number of hardware and/or software features that perform specific functions. For example, the functional blocks of the present disclosure may be implemented by one or more microprocessors or by circuit features for certain functions. The functional blocks of the present disclosure may be implemented in various programming or scripting languages. The functional blocks of the present disclosure may be implemented as algorithms running on one or more processors. The function performed by the functional block of the present disclosure may be performed by a plurality of functional blocks, or the functions performed by the plurality of functional blocks of the present disclosure may be performed by a single functional block. In addition, the present disclosure may employ conventional techniques for setting up an electronic environment, signal processing, and/or data processing.

Furthermore, in the present disclosure, the expressions “greater than” or “less than” are used to determine whether a specific condition has been satisfied or fulfilled, but they are only used to express an example and are not intended to exclude the meaning of “equal to or more than” or “less than or equal to.” Conditions written in the expression “equal to or more than” can be replaced with conditions written in the expression “greater than,” conditions written in the expression “less than or equal to” with conditions written in the expression “less than,” and conditions written in the expression “equal to or more than . . . and less than . . . ” with conditions written in the expression “greater than . . . and less than or equal to . . . .”

Terms or expressions used below, such as “ . . . unit” and “-er,” refer to a unit that processes at least one function or operation, which may be in the form of hardware, software, or a combination of hardware and software.

Unless otherwise defined, all terms used herein, including technical or scientific terms, have meanings commonly understood by a person having ordinary skill in the technical field to which the various embodiments of the present disclosure pertain.

Terms defined in commonly used dictionaries should be interpreted with a meaning consistent with the meaning in the context of the relevant technology, and should not be interpreted in an idealized or overly formal sense unless clearly defined in the various embodiments of the present invention.

The present disclosure relates to a system and method for predicting the number of vehicles waiting at a predetermined future point in time at a charging station for eco-friendly vehicles such as hydrogen or electric vehicles. Hereinafter, the desirable embodiments according to the present disclosure will be described in detail with reference to the attached drawings.

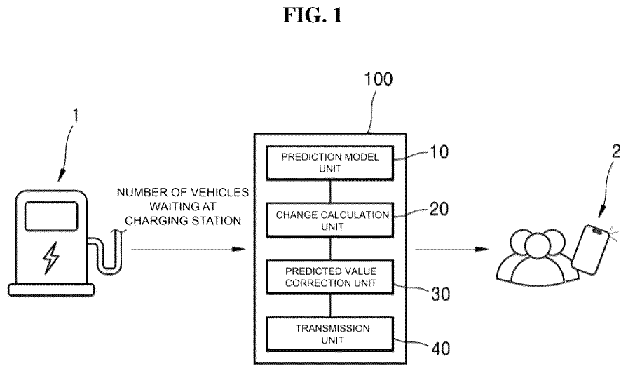

As shown in FIG. 1, a system 100 for predicting the level of congestion at a charging station according to one aspect of the present disclosure may include a prediction model unit 10, a change calculation unit 20, and a predicted value correction unit 30.

The prediction model unit 10 may use an artificial intelligence model to calculate a predicted value for the number of vehicles waiting at a predetermined future point in time. The artificial intelligence model may collect information about the number of vehicles waiting for charging at a charging station during a predetermined period of time, and may be built with the number of waiting vehicles as a dependent variable and factors affecting the number of waiting vehicles as independent variables.

The independent variable may include information on the time at which information on the number of vehicles waiting at a charging station is collected, temperature at the time, humidity at the time, precipitation at the time, etc. In addition, the precipitation information may be divided into types of precipitation, such as rain, showers, sleet, snow, and no precipitation. The information about the time may include detailed variables such as year, month, day, hour, minute, and second. The dependent variable may refer to a variable that is influenced by the independent variable, and may be defined as the number of waiting vehicles being influenced by the independent variable.

In order to build the artificial intelligence model, data on the above-mentioned variables may be preprocessed through the steps of outlier processing, normalization, and interpolation for missing values. In the process of preprocessing the data, ordinary data processing techniques may be applied. According to the present disclosure, a model derived by machine learning or a model derived by deep learning may be applied to the artificial intelligence model. For the model derived by machine learning, any one of machine learning algorithms such as XGBoost, LightGBM, KNeighbors, and RandomForest Regression may be used. In addition, the model derived by deep learning may be either LSTM or GRU of the recurrent neural network (RNN) series.

The prediction model unit 10 may calculate the number of vehicles waiting at a predetermined future point in time, for example, one hour from the current time, according to the artificial intelligence model. Of course, the time when the prediction model unit 10 predicts the number of waiting vehicles is not limited to one hour later. The prediction model unit 10 may be designed to provide predicted values at various time points, and may also provide predicted values at multiple points in time. In the present disclosure, the current time at which prediction is performed may be defined as a prediction time, the time before the prediction time as a past time, and the time after the prediction time as a future time. The prediction model unit 10 may receive information on the number of vehicles waiting at a charging station in real time, and thus continuously and cumulatively calculate predicted values after a predetermined time.

The change calculation unit 20 may calculate variance in the number of vehicles waiting at the prediction time based on the number of vehicles waiting at the prediction time at which a predicted value is calculated and that at a predetermined past time. The variance in the number of waiting vehicles calculated by the change calculation unit 20 may be calculated by the following process. Specifically, the average numbers of waiting vehicles at each time point may be calculated, and the variance in the numbers of waiting vehicles at each time point may be calculated based on the average numbers of waiting vehicles. Next, the ratio of the variance at the prediction time to the difference between the maximum and minimum values of the variances at each time point before the prediction time may be calculated to calculate the variance in the number of waiting vehicles.

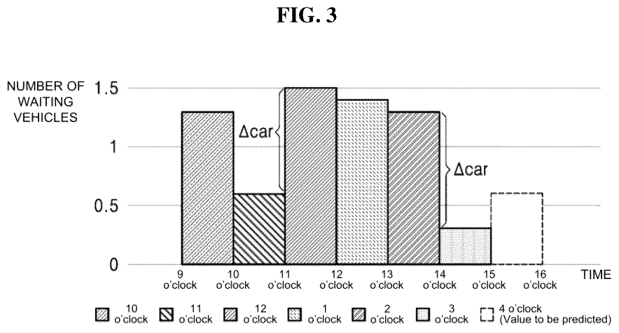

Specifically, as shown in FIG. 3, the average numbers of vehicles waiting at each time point may be calculated by obtaining the average value of the number of waiting vehicles that increases or decreases at one-hour intervals. Referring to FIG. 3, the average number of vehicles waiting at 10 o'clock may be calculated based on the average number of vehicles waiting at a time between 9 and 10 o'clock. In addition, the average number of vehicles waiting at 11 o'clock may be calculated based on the average number of vehicles waiting at a time between 10 and 11 o'clock. The average number of vehicles waiting at each following time point may also be calculated in the same way.

The variance at each time point (Δcar) may be a value calculated by calculating the variance at a predetermined time interval based on the average number of waiting vehicles. FIG. 3 is a diagram conceptually showing the variances in the number of waiting vehicles at each time point, and, with reference thereto, the variances at each time point may be described. As shown in FIG. 3, the difference between the average number of vehicles waiting at a time between 10 and 11 o'clock (the average number of vehicles waiting at 11 o'clock) and the average number of vehicles waiting at a time between 11 and 12 o'clock (the average number of vehicles waiting at 12 o'clock) may be calculated to obtain the variance at the time. That is, the variance in the number of vehicles waiting at 12 o'clock may be calculated by calculating the difference between the average number of vehicles waiting at 12 o'clock and the average number of vehicles waiting at 11 o'clock.

As shown in FIG. 3, when the average number of vehicles waiting at 11 a.m. is subtracted from the average number of vehicles waiting at 12 p.m., the variance in the number of vehicles waiting at 12 p.m. may be given as a positive value. On the other hand, referring to FIG. 3, when the average number of vehicles waiting at 2 p.m. is subtracted from the average number of vehicles waiting at 3 p.m., the variance in the number of vehicles waiting at 3 p.m. may be given as a negative value.

Lastly, the ratio of the variance at the prediction time to the difference between the maximum and minimum values of the variances at each time point before the prediction time may be calculated to calculate the variance in the number of waiting vehicles. The maximum and minimum values of the variances at each time point before the prediction time may refer to the maximum and minimum values of the variances at each time point calculated cumulatively before the prediction time. In other words, the maximum and minimum values of the variances at each time point before the prediction time may be selected. The variance at the prediction time may be calculated by calculating the difference between the average number of vehicles waiting at the prediction time and the average number of vehicles waiting at a certain time a predetermined length of time, e.g., one hour, before the prediction time.

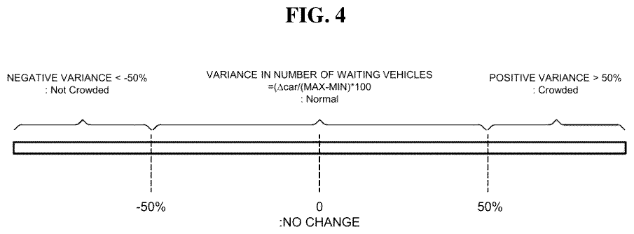

The predicted value correction unit 30 may be designed to correct the predicted value by assigning a weight to each of the predicted value and the actual number of vehicles waiting at the prediction time based on the variance in the number of waiting vehicles calculated by the change calculation unit 20. As shown in FIG. 4, according to an embodiment of the present disclosure, a preset weight may be given to each of the predicted value and the actual number of waiting vehicles based on the level of congestion classified according to the variance in the number of waiting vehicles. The level of congestion may be classified into at least three levels. In addition, the variance in the number of waiting vehicles may be converted into a percentage through Equation 1 below:

{ΔNcar/(Max−Min)}×100 (Equation 1),
wherein ΔNcar denotes variance in the number of waiting vehicles at the prediction time, Max denotes the maximum value of variances at each time point before the prediction time, and Min denotes the minimum value of variances at each time point before the prediction time.

As shown in FIG. 4, when the variance in the number of waiting vehicles at the prediction time calculated by Equation 1 above is equal to or more than +50%, it may be classified as a crowded state; when greater than −50% and less than +50%, as a normal state; and when less than or equal to −50%, as a non-crowded state, and different weights may be assigned depending on the level of congestion. In addition, the weight may be given to each of the predicted value and the actual number of vehicles waiting at the prediction time, and, when the weight given to the predicted value and the weight given to the actual number of waiting vehicles are M and m, respectively, then M+m=1.

According to an embodiment of the present disclosure, the M value in the crowded state may be set to be less than the M value in the non-crowded state, and the m value in the crowded state may be set to be greater than the m value in the non-crowded state. In general, users of a charging station avoid using the charging station at a time when many vehicles are waiting and try to use the charging station at a time when few vehicles are waiting. This means that, when the users avoid using the charging station because a lot of vehicles are currently waiting, the charging station will become free and that, when the users try to use the charging station because few vehicles are currently waiting, the charging station will become congested.

According to the present disclosure, it may be possible to correct a predicted value more accurately by reflecting the above-described behavior patterns of users in the predicted value calculated by the prediction model unit 10 using the artificial intelligence model. When a charging station is currently crowded, there is a possibility that it will become non-crowded after an hour, and, when the charging station is currently not crowded, there is an increased possibility that it will become crowded after an hour. Therefore, compared to the non-crowded state, a weight of a less M value may be assigned to a predicted value calculated by the prediction model unit 10 in the crowded state, and, taking into account the charging time for vehicles already waiting, a value of m(=1−M) may be assigned to the actual number of waiting vehicles, depending on each level of congestion.

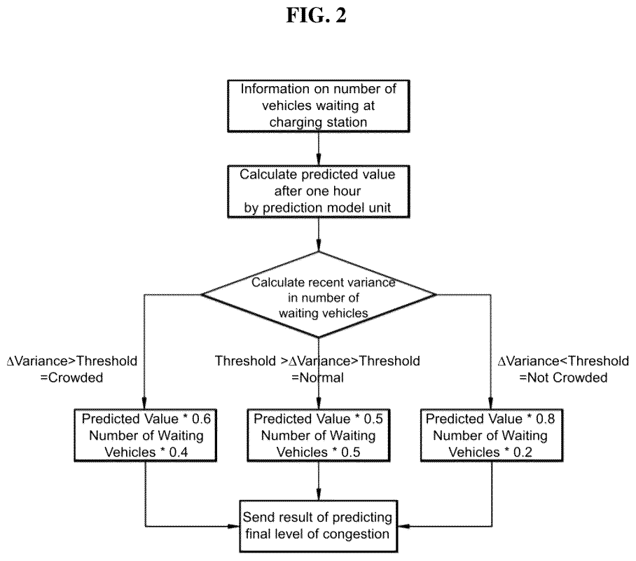

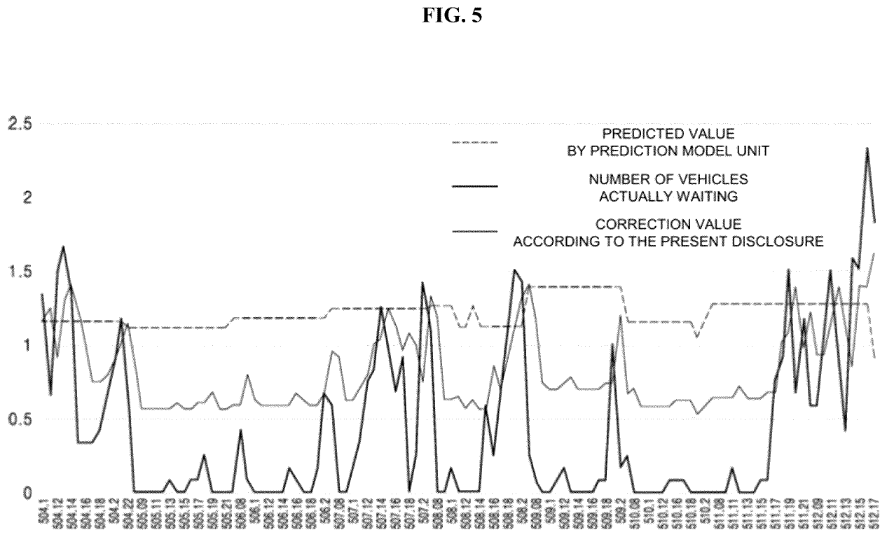

According to an embodiment of the present disclosure, in the crowded state, weights of M=0.55 to 0.65 and m=0.35 to 0.45 may be assigned; in the normal state, weights of M=0.5 and m=0.5 may be assigned; and, in the non-crowded state, weights of M=0.75 to 0.85 and m=0.15 to 0.25 may be assigned. According to an embodiment of the present disclosure, as shown in FIG. 2, in the crowded state, weights of M=0.6 and m=0.4 may be assigned; in the normal state, weights of M=0.5 and m=0.5 may be assigned; and, in the non-crowded state, weights of M=0.8 and m=0.2 may be assigned. Table 1 below is exemplary data showing the result of predicting the variance in the number of waiting vehicles by assigning the weights as shown in FIG. 2, and FIG. 5 shows a comparison between the results of accumulating the variances in the number of waiting vehicles according to the present disclosure over a predetermined period of time and the trend of a predicted value corrected according to the present disclosure.

TABLE 1

| | The average | | | | | |
|---|---|---|---|---|---|---|
| | numbers of | | Variance in | | | |
| | vehicles | Variance at | the number | Predicted | | Predicted |
| | waiting at | each time | of waiting | value by | | value that |
| | each time | point | vehicles | prediction | Application | has been |
| Time | point | (Δcar) | (percentage) | model unit | of weights | corrected |
| 10 o'clock | 1.3333 | | | 1.1579 | | |
| 11 o'clock | 0.6667 | −0.67 | | 1.1579 | | |
| 12 o'clock | 1.5 | 0.83 | 55.33% | 1.1579 | | |
| (current time) | | | (crowded) | | | |
| 1 o'clock | | | | 1.1579 | 1.5 × 0.4 + | 1.2948 |
| | | | | | 1.1579 × 0.6 | |

Referring to Table 1 above, assuming the current time is 12 p.m., the number of vehicles waiting at 1 p.m. is to be predicted. The average number of vehicles waiting at 12 p.m., 1.5, is the average number of vehicles waiting from 11 a.m. to 12 p.m., and the average numbers of vehicles waiting at each time point before the time may be calculated in the same way. The variance at 12 p.m. (Δcar), which is 0.83 as shown above, was obtained by calculating the difference between the average number of vehicles waiting at 12 p.m. and the average number of vehicles waiting at 11 a.m.

The variance in the number of waiting vehicles was calculated as a percentage, and was calculated using Equation 1 above, with ΔNcar set to 0.83, Max set to 0.83, and Min set to −0.67. Meanwhile, the predicted values obtained by the prediction model unit were given with reference to FIG. 5 showing that the variation in the values is slight and there is little difference therebetween. The variance in the number of waiting vehicles calculated in such a way is 55.33%, which is more than 50%, so that a weight of 0.6 is given to the predicted value obtained by the prediction model unit and a weight of 0.4 is given to the average number of waiting vehicles at 12 p.m., the current time. As a result, the number of vehicles waiting at 1 p.m. was revised to 1.2948 by applying a weight to the predicted value of 1.1579 by the prediction model unit.

FIG. 5 shows how the actual number of vehicles waiting at a hydrogen charging station changed during the period from May 4, 2022 to May 12, 2022, and also shows how the predicted values obtained by the prediction model unit 10 and the values obtained by correcting the predicted values according to the present disclosure changed. It is seen that the trend of the values corrected by weighting the predicted values by the prediction model unit 10 according to the present disclosure is very close to the trend of the actual number of waiting vehicles. As shown in FIG. 5, the mean square errors (MSEs) of the predicted values by the prediction model unit 10 and the mean square error according to the present disclosure are respectively 0.9438 and 0.325, which means that accuracy or sensitivity has been significantly improved by about 66%.

A predicted value corrected by the predicted value correction unit 30 may be transmitted externally by the transmission unit 40. For example, the transmission unit 40 may transmit a predicted value that has been corrected to a user terminal (e.g., PCs, mobile phones, etc.). By receiving a predicted value that has been corrected, a user may obtain information about the number of vehicles waiting at a predetermined future point in time and use it as a reference to decide whether to use the charging station.

Meanwhile, according to another aspect of the present disclosure, a method of predicting the level of congestion at charging stations is provided.

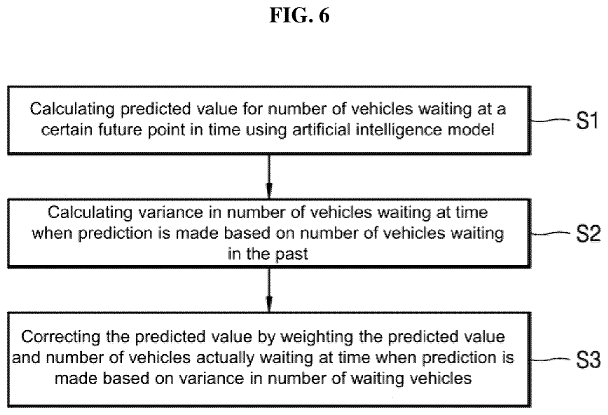

As shown in FIG. 6, the method of predicting the level of congestion at charging stations according to an embodiment of the present disclosure may involve the step of calculating a predicted value S1, the step of calculating variation S2, and the step of correcting a predicted value S3.

In the step of calculating a predicted value S1, information may be collected on the number of vehicles waiting at a charging station for charging during a predetermined period of time, an artificial intelligence model may be built with the number of waiting vehicles as a dependent variable and the factors affecting the number of waiting vehicles as independent variables, and, based on the artificial intelligence model, a predicted value for the number of vehicles waiting at a predetermined future time point may be calculated. The step S1 may be performed by the prediction model unit 10. What has been described above may be applied to the construction of the artificial intelligence model. In other words, the processes such as selection of the independent and dependent variables, processing of data, selection of an artificial intelligence model, etc. may be performed as described above. The artificial intelligence model may be derived by any one of machine learning algorithms such as XGBoost, LightGBM, KNeighbors, and RandomForest Regression or by either LSTM or GRU of the recurrent neural network (RNN) series. In addition, according to an embodiment of the present disclosure, a predicted value calculated in the step of calculating a predicted value S1 may be calculated at 1-hour intervals. Of course, the 1-hour interval may be adjusted to be shorter or longer.

In the step of calculating variation S2, based on the number of vehicles waiting at a prediction time at which the predicted value is calculated and that at a predetermined past time, the variance in the number of vehicles waiting at the prediction time may be calculated. The step S2 may be performed by the change calculation unit 20. In other words, to calculate the variance in the number of waiting vehicles, the average numbers of vehicles waiting at each time point may be calculated, the variance in the numbers of waiting vehicles at each time point may be calculated based on the average number of waiting vehicles, and the ratio of the variance at the prediction time to the difference between the maximum and minimum values of the variances at each time point before the prediction time may be calculated. The ratio may be converted into a percentage and expressed as the variance in the number of waiting vehicles, and the level of congestion may be classified as follows: 1) If the variance in the number of waiting vehicles≥+50%, crowded; 2) If −50%<the variance in the number of waiting vehicles<+50%, normal; and 3) If the variance in the number of waiting vehicles≤−50%, not crowded. According to an embodiment of the present disclosure, the congestion level may be classified into at least three levels. The process described with reference to FIGS. 3 to 4 and Table 1 may be applied as described above in the process of calculating the variance in the number of waiting vehicles. The variance in the number of waiting vehicles may be calculated at 1-hour intervals, as the predicted value is. The variance in the number of waiting vehicles may be calculated at the same time interval as the predicted value.

In the step of correcting a predicted value S3, the predicted value may be corrected by assigning a weight to each of the predicted value and the actual number of vehicles waiting at the prediction time based on the variance in the number of waiting vehicles calculated in the step of calculating variation S2. The step S3 may be performed by the predicted value correction unit 30. According to an embodiment of the present disclosure, in the step of correcting a predicted value S3, a preset weight may be given to each of the predicted value and the actual number of waiting vehicles based on the level of congestion classified according to the variance in the number of waiting vehicles.

Specifically, when the weight given to the predicted value is M and the weight given to the actual number of waiting vehicles is m, M in the crowded state may be set less than M in the non-crowded state, and m in the crowded state may be set greater than m in the non-crowded state. Here, the relationship M+m=1 may be established. The reason M in the crowded state is less than M in the non-crowded state is because, as described above, a crowded charging station is likely to become free due to the above-mentioned behavior patterns of users, and, in contrast, a charging stations that is not congested is likely to become congested.

More specifically, in the crowded state, weights of M=0.55 to 0.65 and m=0.35 to 0.45 may be assigned; in the normal state, weights of M=0.5 and m=0.5 may be assigned; and, in the non-crowded state, weights of M=0.75 to 0.85 and m=0.15 to 0.25 may be assigned. According to an embodiment of the present disclosure, in the crowded state, weights of M=0.6 and m=0.4 may be assigned; in the normal state, weights of M=0.5 and m=0.5 may be assigned; and, in the non-crowded state, weights of M=0.8 and m=0.2 may be assigned.

A predicted value that has been corrected in the step of correcting a predicted value S3 may be transmitted externally. The predicted value that has been corrected may be transmitted to a user terminal (e.g., PCs, mobile phones, etc.) by the transmission unit 40. By receiving the predicted value that has been corrected, a user may obtain information about the number of vehicles waiting at a predetermined future point in time and use it as a reference to decide whether to use the charging station.

As such, the method of predicting the level of congestion at a charging station according to an embodiment of the present disclosure may actually provide the same action or effect as the system 100 for predicting the level of congestion at a charging station. That is, as shown in FIG. 5, the trend of the values predicted by correcting the number of waiting vehicles according to the present disclosure may be close to the trend of the actual number of vehicles waiting.

As described above, in the case of the system and the method for predicting the level of congestion at a charging station according to an embodiment of the present disclosure, the number of waiting vehicles may be predicted for the first time using an artificial intelligence model, and the value that has been predicted as mentioned above may be corrected by reflecting the behavior patterns of users to decide whether to use a charging station based on the level of congestion, so that it may be possible to improve reliability or sensitivity by reflecting the ever-changing conditions in the environment in predicted values.

According to the present disclosure, it may be possible to follow the trend of changes in the actual number of waiting vehicles very accurately by giving different weights depending on the level of congestion. Accordingly, users can decide whether to use a charging station based on more accurate results, so that convenience may be improved, the density of charging stations may be distributed, and the prediction results may be used to predict demand for charging accurately.

As such, the present disclosure has been described in detail with the desirable embodiments. However, the present disclosure is not limited to the above-described embodiments, and various modifications may be possible within the scope of the present disclosure.

What is claimed is:

1. A system for predicting the level of congestion at a charging station, comprising:
a prediction model unit that collects information on the number of vehicles waiting at a charging station for charging during a predetermined period of time and calculates a predicted value for the number of vehicles waiting at a predetermined future time point based on the number of waiting vehicles and the factors affecting the number of waitng vehicles;
a change calculation unit that calculates the variance in the number of vehicles waiting at a prediction time based on the number of vehicles waiting at the prediction time at which the predicted value is calculated and that at a predetermined past time; and
a predicted value correction unit that corrects the predicted value by giving a weight to each of the predicted value and the actual number of vehicles waiting at the prediction time based on the variance in the number of waiting vehicles calculated by the change calculation unit.

2. The system of claim 1, wherein, to calculate the variance in the number of waiting vehicles using the change calculation unit, the average numbers of vehicles waiting at each time point are calculated, the variance in the numbers of waiting vehicles at each time point is calculated based on the average numbers of waiting vehicles, and the ratio of the variance at the prediction time to the difference between the maximum and minimum values of the variances at each time point before the prediction time is calculated.

3. The system of claim 1, wherein a preset weight is given to each of the predicted value and the actual number of waiting vehicles based on the level of congestion classified according to the variance in the numbers of waiting vehicles.

4. The system of claim 3, wherein the level of congestion is classified into at least three levels.

5. The system of claim 2, wherein the ratio is converted into a percentage and expressed as the variance in the number of waiting vehicles,
the level of congestion is classified as follows:
1) If the variance in the number of waiting vehicles≥+50%, crowded;
2) If −50%<the variance in the number of waiting vehicles<+50%, normal; and
3) If the variance in the number of waiting vehicles≤−50%, not crowded, and different weights are given depending on the level of congestion.

6. The system of claim 3, wherein, when the weight given to the predicted value and the weight given to the actual number of waiting vehicles are M and m, respectively, and M+m=1, the M value in the crowded state is less than the M value in the non-crowded state, and the m value in the crowded state is greater than the m value in the non-crowded state.

7. The system of claim 5, wherein, when the weight given to the predicted value and the weight given to the actual number of waiting vehicles are M and m, respectively, and M+m=1, in the crowded state, weights of M=0.55 to 0.65 and m=0.35 to 0.45 are given; in the normal state, weights of M=0.5 and m=0.5 are given; and, in the non-crowded state, weights of M=0.75 to 0.85 and m=0.15 to 0.25 are given.

8. The system of claim 1, wherein the predicted value and the variance in the number of waiting vehicles are calculated at 1-hour intervals.

9. The system of claim 1, wherein the prediction model unit calculates a measured value for the number of vehicles waiting at a predetermined future time point based on any one of machine learning algorithms such as XGBoost, LightGBM, KNeighbors, and RandomForest Regression.

10. The system of claim 1, wherein the prediction model unit calculates a measured value for the number of vehicles waiting at a predetermined future time point based on either LSTM or GRU of the recurrent neural network (RNN) series.

11. A method of predicting the level of congestion at a charging station, comprising:
calculating a predicted value, where information on the number of vehicles waiting at a charging station for charging during a predetermined period of time is collected and a predicted value for the number of vehicles waiting at a predetermined future time point is calculated based on the number of waiting vehicles and the factors affecting the number of waiting vehicles;
calculating variance, where the variance in the number of vehicles waiting at a prediction time is calculated based on the number of vehicles waiting at the prediction time at which the predicted value is calculated and that at a predetermined past time; and
correcting a predicted value, where the predicted value is corrected by giving a weight to each of the predicted value and the actual number of vehicles waiting at the prediction time based on the variance in the number of waiting vehicles calculated in the calculating of variance.

12. The method of claim 11, wherein, to calculate the variance in the number of waiting vehicles in the calculating of variance, the average numbers of vehicles waiting at each time point are calculated, the variance in the numbers of waiting vehicles at each time point is calculated based on the average numbers of waiting vehicles, and the ratio of the variance at the prediction time to the difference between the maximum and minimum values of the variances at each time point before the prediction time is calculated.

13. The method of claim 11, wherein a preset weight is given to each of the predicted value and the actual number of waiting vehicles based on the level of congestion classified according to the variance in the number of waiting vehicles.

14. The method of claim 13, wherein the level of congestion is classified into at least three levels.

15. The method of claim 12, wherein the ratio is converted into a percentage and expressed as the variance in the number of waiting vehicles,
the level of congestion is classified as follows:
1) If the variance in the number of waiting vehicles≥+50%, crowded;
2) If −50%<the variance in the number of waiting vehicles<+50%, normal; and
3) If the variance in the number of waiting vehicles≤−50%, not crowded, and different weights are given depending on the level of congestion.

16. The method of claim 13, wherein, when the weight given to the predicted value and the weight given to the actual number of waiting vehicles are M and m, respectively, and M+m=1, the M value in the crowded state is less than the M value in the non-crowded state, and the m value in the crowded state is greater than the m value in the non-crowded state.

17. The method of claim 15, wherein, when the weight given to the predicted value and the weight given to the actual number of waiting vehicles are M and m, respectively, and M+m=1, in the crowded state, weights of M=0.55 to 0.65 and m=0.35 to 0.45 are given; in the normal state, weights of M=0.5 and m=0.5 are given; and, in the non-crowded state, weights of M=0.75 to 0.85 and m=0.15 to 0.25 are given.

18. The method of claim 11, wherein the predicted value and the variance in the number of waiting vehicles are calculated at 1-hour intervals.

19. The method of claim 11, wherein, in the calculating of a predicted value, a predicted value for the number of vehicles waiting at a predetermined future time point is calculated based on any one of machine learning algorithms such as XGBoost, LightGBM, KNeighbors, and RandomForest Regression.

20. The method of claim 11, wherein, in the calculating of a predicted value, a predicted value for the number of vehicles waiting at a predetermined future time point is calculated based on either LSTM or GRU of the recurrent neural network (RNN) series.
